(19) United States
(12) Patent Application Publication
(10) Pub. No.: US 2008/0091657 A1
(43) Pub. Date: Apr. 17, 2008

(54) Facility Search Device

(76) Inventor: Noboru Yamazaki, Iwaki-city (JP)

Correspondence Address: ALPINE/BHGL, P.O. Box 10395, Chicago, IL, 60610, US

(21) Appl. No.: 11/865,503

(22) Filed: Oct. 1, 2007

(30) Foreign Application Priority Data
Oct. 12, 2006 (JP) 2006-278700

(51) Int. Cl. G06F 17/30; G01C 21/00

(52) U.S. Cl. 707/3; 701/200; 707/E17.014

(57) ABSTRACT

Facility search devices capable of searching for an exclusive facility associated with a desired professional sport team are disclosed. The facility search devices search for facilities regardless of a change in the name of the facility. Facility search devices are additionally disclosed that are capable of searching for an exclusive facility associated with a professional sport team based on a team name of the professional sport team.

### RELATED APPLICATIONS

The present application claims priority to Japanese Patent Application Serial Number 2006-278700, filed Oct. 12, 2006, the entirety of which is hereby incorporated by reference.

### FIELD OF THE INVENTION

The present invention relates to a facility search device, and more particularly to a facility search device for searching for a desired facility.

### BACKGROUND OF THE INVENTION

Generally, professional sports teams such as those of baseball, American football, soccer, basketball, ice hockey or the like own exclusive stadiums that they use as their home. In recent years, stadiums have been named names that are different from the name of the team associated with the stadium.

Searching systems that search facilities as potential destination candidates according to search conditions specified by a user have conventionally been mounted in an on-vehicle navigation device in order to support setting of a destination for driving. In such a searching system, searching for a stadium as a candidate of the destination was possible by inputting a stadium name as a search condition. See for example Japanese Patent Laid-open No. 2005-20757.

However, as described above, in the case where a name of a stadium that the user tries to search for is different from the team name of a team that uses the stadium as home, the stadium name could not be used as a search condition unless the user remembers the official stadium name. Because a name of a stadium may be change many times depending on a sponsor of a team or the stadium, a search for a destination based on a stadium name could not be done unless the user remembers a current name. Accordingly, improved systems and methods that can search for a destination regardless of a change of the name of the destination are desirable.

### SUMMARY OF THE INVENTION

To achieve the above-described object, a facility search device according to the present invention may include a function that can search for an exclusive facility associated with a professional sport team, in which the device is capable of searching the exclusive facility for the professional sport team based on a team name of the professional sport team.

Further, another facility search device according to the present invention may include: a sport facility name list display processing device that performs a process of displaying a list of facility names regarding the exclusive facility for a professional sport team on a display section; a sport team name list display processing device that performs a process of displaying a list of team names severally corresponding to each facility in the list of the facility names on the display section in the state where corresponding relation with the facility name is distinguishable; and a display switching processing device that performs a process of switching a display of the list of the facility names by the sport facility name list display processing device and a display of the list of the team names by the sport team name list display processing device according to the input operation of a user, in which the device is formed to be capable of searching for an exclusive facility for a professional sport team based on a team name by switching the display of the list of the facility names and the display of the list of the team names.

Moreover, another facility search device according to the present invention may include: a type input device for inputting at least one of a facility type and a professional sport type selected from candidates of these types; and an address input device for inputting facility address, in which the sport facility name list display processing device and the sport team name list display processing device are formed to display the list of the facility names or the team names regarding an exclusive facility for a professional sport team corresponding to the input result of the type input device and the address input device on the display section.

Furthermore, another facility search device according to the present invention is that the sport facility name list display processing device is formed to be capable of displaying a plurality of names regarding the same facility.

Further, another facility search device according to the present invention may include: a sport type input device for inputting a professional sport type by selecting from candidates of the type; a first sport team name list display processing device that performs a process of displaying a list of names of professional sport teams that belong to a type inputted by the sport type input device on a display section in the state that a user can select an arbitrary team in the list; a second sport team name list display processing device that performs a process of displaying the list of names of Minor teams affiliated with a team which is selected by the user out of the list of team names displayed by the first sport team name list display processing device on the display section in the state that the user can select an arbitrary Minor team in the list; and a Minor team display processing device that performs a process of displaying the information of exclusive facility for the Minor team selected by the user out of the names of Minor teams displayed by the second sport team name list display processing device on the display section.

Moreover, another facility search device according to the present invention is that the Minor team display processing device is formed to display at least one of address and peripheral map together with a facility name as the information of the exclusive facility for Minor teams.

Furthermore, another facility search device according to the present invention is that the professional sport teams are Major League teams in the U.S. professional baseball and the Minor teams in the Minor League are affiliated with the Major League teams.

Further, another facility search device according to the present invention may include: a team name characters input device that inputs the characters of the name of a professional sport team; and a facility information display processing device that performs a process of displaying the information of an exclusive facility for a professional sport team corresponding to the team name inputted by the team name characters input device on the display section.

Moreover, another facility search device according to the present invention may include: a facility name characters input device that inputs the characters of the name of an exclusive facility for a professional sport team, in which the facility information display processing device is also capable of performing a process of displaying the information of an exclusive facility for a professional sport team corresponding to the facility name inputted by the facility name characters input device on a display section.

Furthermore, another facility search device according to the present invention is that the facility information display processing device is formed to display at least one of address and peripheral map as the information of the exclusive facility for a professional sport team together with a facility name.

Further, another facility search device according to the present invention is that the device is formed to be capable of searching an exclusive facility for a professional sport team by using database storing information regarding exclusive facilities for professional sport teams, wherein the database includes information regarding the date when the names of exclusive facilities for professional sport teams are changed and the facility names after change from present to several years ahead are stored in the database, and on and after the change date, the device is formed to be capable of searching the exclusive facility for the professional sport team by using the facility name after the change.

Moreover, another facility search device according to the present invention is that even on and after the change date, the device is formed to be capable of searching an exclusive facility for a professional sport team by using a facility name before change.

Furthermore, another facility search device according to the present invention is formed to be capable of acquiring a de of a change of the name of the exclusive facility for a professional sport team and information regarding the facility name after the change from present to several years ahead at once by one time annual update of the database.

Further, another facility search device according to the present invention is that the exclusive facility for a professional sport team is a stadium that the professional sport team uses as home.

Moreover, another facility search device according to the present invention has a function that can search an exclusive facility for live performance groups, in which the device is formed to be capable of searching the exclusive facility for live performance groups based on the name of the live performance group.

Furthermore, another facility search device according to the present invention may include: a live performance facility name list display processing device that performs a process of displaying a list of facility names regarding the exclusive facility for live performance groups on a display section; a group name list display processing device that performs a process of displaying a list of group names severally corresponding to each facility in the list of facility names on the display section in the state where corresponding relation with the facility name is distinguishable; and a display switching processing device that performs a process of switching display of the list of the facility names by the live performance facility name list display processing device and display of the list of the group names by the group name list display processing device according to the input operation of a user, in which the device is formed to be capable of searching an exclusive facility for live performance groups based on a group name by switching the display of the list of the facility names and the display of the list of the group names.

Further, another facility search device according to the present invention may include: a type input device for inputting at least one of a facility type and a performance content type by selecting from candidates of the types; and an address input device for inputting a facility address, in which the live performance facility name list display processing device and the group name list display processing device are formed to display the list of the facility names or the group names regarding the exclusive facility for live performance groups corresponding to the input result of the type input device and the address input device on the display section.

Moreover, another facility search device according to the present invention is that the live performance facility name list display processing device is formed to be capable of displaying a plurality of names regarding the same facility.

Furthermore, another facility search device according to the present invention is provided with: a group name characters input device that inputs the characters of the group name for live performance groups; and a facility information display processing device that performs a process of displaying the information of an exclusive facility for live performance groups corresponding to the group name inputted by the group name characters input device on a display section.

Further, another facility search device according to the present invention may include: a facility name characters input device that inputs the characters of the name of an exclusive facility for live performance groups, in which the facility information display processing device is also capable of performing a process of displaying the information of an exclusive facility for live performance groups corresponding to the facility name inputted by the facility name characters input device on a display section.

Moreover, another facility search device according to the present invention is that the facility information display processing device is formed to display at least one of address and peripheral map as the information of the exclusive facility for the live performance groups together with a facility name.

Furthermore, another facility search device according to the present invention is formed to be capable of searching the exclusive facility for live performance groups by using database storing information regarding exclusive facilities for live performance groups, wherein the database includes the date when the name of exclusive facilities for live performance groups is changed and information regarding facility name after change from present to several years ahead are stored in the database, and on and after the change date, the device is formed to be capable of searching an exclusive facility for live performance groups by using a facility name after change.

Further, another facility search device according to the present invention is that even on and after the change date, the device is formed to be capable of searching an exclusive facility for live performance groups by using a facility name before change as well.

Moreover, another facility search device according to the present invention is formed to be capable of acquiring the change date of the name of the exclusive facility for live performance groups and information regarding the facility name after change from present to several years ahead at once by annual update of the database.

Furthermore, another facility search device according to the present invention is that the live performance group includes at least one of a theater company and an orchestra, and the exclusive facility for live performance groups includes at least one of a theater and a concert hall.

Further, another facility search device according to the present invention has a function that searches a facility holding an event, in which the device is formed to be capable of searching the facility holding the event based on an event name.

Moreover, another facility search device according to the present invention may include: a holding facility name list display processing device that performs a process of displaying a list of facility names regarding the facility holding the event on a display section; an event name list display processing device that performs a process of displaying a list of event names severally corresponding to each facility in the list of facility names on the display section in the state where corresponding relation with the facility name is distinguishable; and a display switching processing device that performs a process of switching display of the list of the facility names by the holding facility name list display processing device and display of the event name list by the event name list display processing device according to the input operation of a user, in which the device is formed to be capable of searching an event holding facility based on an event name by switching the display of the list of the facility names and the display of an event name list.

Furthermore, another facility search device according to the present invention is provided with: a type input device for inputting at least one of a facility type and an event type by selecting from candidates of the types; and an address input device for inputting facility address, in which the holding facility name list display processing device and the event name list display processing device are formed to display the list of the facility names or the names of the events held at the facility corresponding to the input result of the type input device and the address input device on the display section.

Further, another facility search device according to the present invention is that the holding facility name list display processing device is formed to be capable of displaying a plurality of names regarding the same facility.

Moreover, another facility search device according to the present invention may include: an event name characters input device that inputs the characters of an event name; and a facility information display processing device that performs a process of displaying the information of the facility holding the event corresponding to the event name inputted by the event name characters input device on a display section.

Furthermore, another facility search device according to the present invention may include: a facility name characters input device that inputs the characters of the name of a facility holding an event, in which the facility information display processing device is also capable of performing a process of displaying the information of the facility holding the event corresponding to the facility name inputted by the facility name characters input device on a display section.

Further, another facility search device according to the present invention is that the facility information display processing device is formed to display at least one of address and peripheral map as the information of the facility holding the event together with a facility name.

Moreover, another facility search device according to the present invention is formed to be capable of searching a facility holding an event by using database storing information regarding facilities holding events, wherein the database includes the date when the names of the facilities holding events are changed and information regarding the facility names after change from present to several years ahead are stored in the database, and on and after the change date, the device is formed to be capable of searching an event holding facility by using the facility name after change.

Furthermore, another facility search device according to the present invention is that even on and after the change date, the device is formed to be capable of searching a facility holding an event by using a facility name before change as well.

Further, another facility search device according to the present invention is formed to be capable of acquiring information regarding the date when the name of the facility holding the event is changed and the facility name after change from present to several years ahead at once by annual update of the database.

Moreover, another facility search device according to the present invention is that the event includes a sport event.

Furthermore, another facility search device according to the present invention is used in an on-vehicle navigation device. Then, according to these configurations, search of an exclusive facility for a desired professional sport team is made possible based on a team name in on-vehicle navigation device.

### BRIEF DESCRIPTION OF THE DRAWINGS

FIG. 1 is a block diagram showing one embodiment of an on-vehicle navigation device including a facility search device.

FIG. 2 is a diagram illustrating a first operation screen for searching for a facility.

FIG. 3 is a diagram illustrating a second operation screen for searching for a facility.

FIG. 4 is a diagram illustrating a third operation screen for searching for a facility.

FIG. 5 is a diagram illustrating a fourth operation screen for searching for a facility.

FIG. 6 is a diagram illustrating a fifth operation screen for searching for a facility.

FIG. 7 is a diagram illustrating a sixth operation screen for searching for a facility.

FIG. 8 is a diagram illustrating a seventh operation screen for searching for a facility.

FIG. 9 is a diagram illustrating a first stadium name list display screen.

FIG. 10 is a diagram illustrating a display state of a sort/switch item selection screen on the first stadium name list display screen.

FIG. 11 is a diagram illustrating a stadium name list display screen.

FIG. 12 is a diagram illustrating a team name list display screen.

FIG. 13 is a diagram illustrating a destination confirmation screen.

FIG. 14 is a diagram illustrating a MLB team name list display screen.

FIG. 15 is a diagram illustrating a character input screen.

FIG. 16 is a diagram illustrating a concert hall name list display screen.

FIG. 17 is a diagram illustrating a display state of the sort/switch item selection screen on the concert hall name list display screen.

FIG. 18 is a diagram illustrating an orchestra name list display screen.

FIG. 19 is a diagram illustrating a circuit name list display screen.

FIG. 20 is a diagram illustrating a display state of the sort/switch item selection screen on the circuit name list display screen.

FIG. 21 is a diagram illustrating a race name list display screen.

### DESCRIPTION OF THE PREFERRED EMBODIMENTS

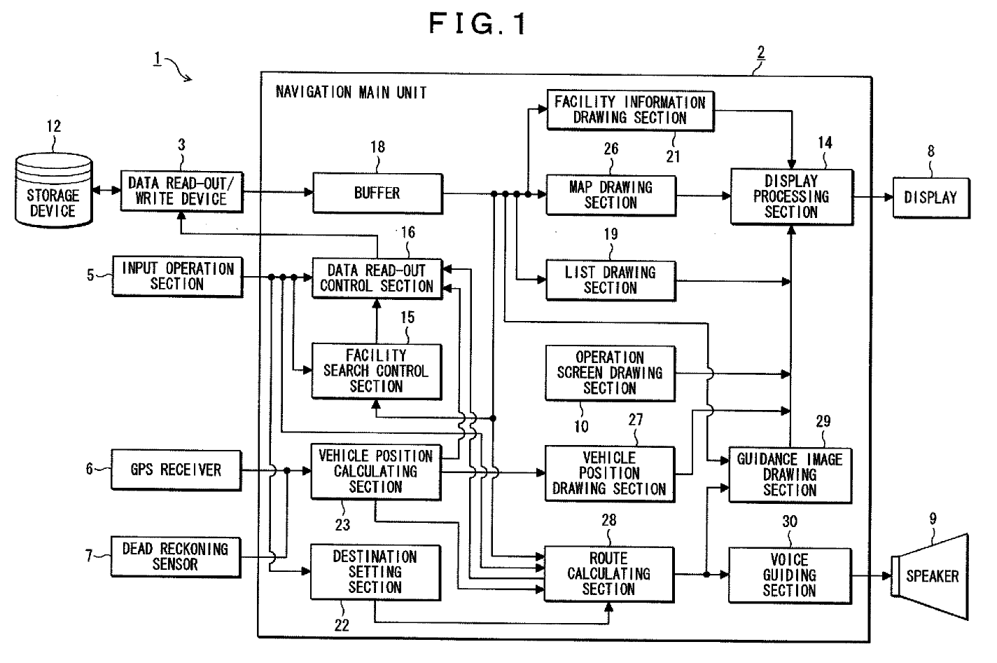

FIG. 1 is a diagram of an on-vehicle navigation device 1 that includes a facility search device. As shown in FIG. 1, the on-vehicle navigation device 1 may include a navigation main unit 2, a data read-out/write device 3, an input operation section 5, a GPS receiver 6 and a dead reckoning sensor 7 severally connected to the input side of the navigation main unit 2, and a display 8 and a speaker 9 severally connected to the output side of the navigation main unit 2.

In this embodiment, the input operation section 5 functions as a type input device and a sport type input device. In other words, the user, in searching an exclusive facility for a desired professional sport team (hereinafter, abbreviated as sport team exclusive facility), can perform the input operation of a type of professional sport team and a type of facility as a search condition using the input operation section 5. The input operation of a professional sport team type is not limited to sports types that are different from each other such as baseball, basketball, American football and the like, but may be also an operation of selecting a further segmented type in the same sport such as Major League, Tripple-A, and Double-A in American baseball.

Further, the input operation section 5 functions as an address input device where the user can perform the input operation of an address as a search condition in searching for a desired sport team exclusive facility. Note that the input operation of an address may roughly specify an area where a sport team exclusive facility is located such as specifying only states in the U.S., for example.

Moreover, the input operation section 5 functions as a team name characters input device where the user can perform the character input operation of a team name corresponding to a desired sport team exclusive facility as a search condition in searching for the desired sport team exclusive facility.

Furthermore, the input operation section 5 functions as a facility name characters input device where the user can perform the character input operation of the name of a desired sport team exclusive facility as a search condition in searching for the desired sport team exclusive facility.

In addition, the input operation section 5 can be used to perform various other input operations for searching for a desired sport team exclusive facility. The input operation using the input operation section 5 will be performed on an operation screen for searching a facility, as described in more detail below.

Note that the input operation section 5 is also used for various input operations for a navigation apparatus such as inputting a route search condition other than an input operation for searching a sport team exclusive facility. The input operation section 5 may be a remote controller, a touch panel on the display 8, a linear encoder or the like, for example.

A storage device 12 such as a hard disc drive and so on is connected to the data read-out/write device 3. The storage device 12 may store a database that includes various types of data such as map data and search data (hereinafter, referred to as navigation DB). In one embodiment, the navigation DB also functions as database storing data regarding sport team exclusive facilities. The navigation DB may store data such as associations between a facility name, a team name, an address, a type of facility, a type of sport, and the like, regarding a sport team exclusive facility.

The navigation main unit 2 has an operation screen drawing section 10. The operation screen drawing section 10 creates the drawing data for various operation screens such as a menu screen, an operation screen for searching a facility, or other various operation screens for use in searching for a desired sport team exclusive facility, and outputs the created drawing data.

A display processing section 14 may be connected between the operation screen drawing section 10 and the display 8 so that the drawing data of an operation screen outputted from the operation screen drawing section 10 is inputted to the display processing section 14. Then, the display processing section 14 displays an operation screen corresponding to the inputted drawing data of the operation screen on the display 8.

The result of the input operation produced by operating the operation screen currently displayed on the display 8 is inputted from the input operation section 5 to the operation screen drawing section 10. If the result of the input operation from the input operation section 5 is an operation result having the content instructing to display a new operation screen, the operation screen drawing section 10 creates the drawing data of the new operation screen and outputs it to the display processing section 14.

A facility search control section 15 is connected to the input operation section 5, and is also connected to the data read/write device 3 via a data read-out control section 16. An input operation result produced by operating an operation screen for searching for a facility is inputted from the input operation section 5 to the facility search control section 15. Then, the facility search control section 15 outputs a read-out request of the data of sport team exclusive facility that satisfies the result of input operation (search condition) produced by operating the operation screen for searching for a facility (hereinafter, referred to as appropriate sport team exclusive facility) to the data read-out/write device 3. It will be appreciated that there are cases where the input operation of the search condition is performed a plurality of times by sequentially using a plurality of operation screens for searching a facility. Further, there are cases where a plurality of appropriate sport team exclusive facilities exists.

According to the read-out request, the data read-out/write device 3 reads out sport team exclusive facility data regarding an appropriate sport team exclusive facility (hereinafter, referred to as appropriate sport team exclusive facility data) from the navigation DB stored in the storage device 12. Then, the data read-out/write device 3 temporarily stores the read out of the appropriate sport team exclusive facility data in the buffer 18 connected to the data read-out/write device 3.

A list drawing section 19 is connected between the buffer 18 and the display processing section 14. The list drawing section 19, together with the display processing section 14 and the facility search control section 15, functions as a sport facility name list display processing device, a sport team name list display processing device, and a display switching step device. In other words, the facility search control section 15 reads out appropriate sport team exclusive facility data satisfying at least one condition of an address, a type of facility, and a type of sport as the search condition inputted using the input operation section 5 via the data read-out control section 16 and the data read-out/write device 3 from the navigation DB. The facility search control section 15 then stores the read out appropriate sport team exclusive facility data in the buffer 18.

The list drawing section 19 acquires the appropriate sport team exclusive facility data stored in the buffer 18, and selectively creates drawing data for displaying the list of names of the appropriate sport team exclusive facility (hereinafter, referred to as facility name list drawing data) or drawing data for displaying the list of team names corresponding to appropriate sport team exclusive facility in a state where corresponding relation with facility names is distinguishable (hereinafter, referred to as team name list drawing data) using the acquired appropriate sport team exclusive facility data. The facility name list drawing data, or the team name list drawing data created by the list drawing section 19, is outputted to the display processing section 14.

Then, the display processing section 14 selectively performs a display process of the list of facility names using the facility name list drawing data or the list of team names using the team name list drawing data on the display 8.

Note that a selection in which either the list of facility names or the list of team names should be displayed is determined by displaying an operation screen on which the selection can be performed (for example, sort/switch item selection screen 89 to be described later) and based on the input operation (selection) of the user to the operation screen.

Thus, either the list of facility names or the list of team names is displayed in the state where a corresponding relation between facility names and team names is distinguishable based on switching the display of the both lists on the display 8. Specifically, in both the list of facility names and the list of team names, the corresponding relation between facility names and team name may be distinguishable to show distance and direction of the facility beside the facility name or the team name. Alternatively, facility names in the list of facility names and team names in the list of team names may be displayed in the same order. With this method, the user can easily distinguish the corresponding relation between facility names and team name in order to alternately see both lists based on switching the display. Therefore, in this embodiment, based on switching the display of the facility name list and the display of the team name list, user can search desired sport team exclusive facility.

Further, in this embodiment, the list drawing section 19 also functions as the first sport team name list display processing device. In other words, the list drawing section 19, in the case where a professional sport team specified by the input operation of a type of professional sport team as a search condition is a team having an affiliated Minor League team (hereinafter, referred to as Major League team), creates drawing data for displaying the team name list of Major League teams as a team name list drawing data in the state where a Major League team in the list is selectable. Then, the display processing section 14, together with the list drawing section 19, functions as the first sport team name list display processing so that based on the drawing data created by the list drawing section 19, the team name first of Major League teams is displayed on the display 8 in the state where the user can select a Major League team in the list.

As team names are displayed by the first sport team name list display processing device, Major League team names of American baseball can be given, for example. In this case, affiliated Minor League teams are Minor League teams such as Tripple-A and Double-A.

Moreover, in this embodiment, the list drawing section 19 functions as the second sport team name list display processing device. In other words, the list drawing section 19 creates drawing data for displaying the list of names of Minor League teams affiliated with a team selected by the user from the list of team names displayed by the first sport team name list display processing device in the state where a Minor League team in the list can be selected (hereinafter, referred to as Minor team name drawing data), and outputs the data to the display processing section 14.

Then, the display processing section 14, together with the list drawing section 19, functions as the second sport team name list display processing device so that based on the Minor League team name drawing data, the list of Minor League team names is displayed on the display 8 in the state where the user can select a Minor League team in the list.

In addition to the above-described configuration, a facility information drawing section 21 is connected between the buffer 18 and the display processing section 14, and the facility information drawing section 21. Together with the display processing section 14 and the facility search control section 15, the facility information drawing section 21 functions as a Minor League team display processing device and a facility information display processing device.

In other words, the facility search control section 15 outputs a read-out request of sport team exclusive facility data regarding exclusive facility for Minor League teams that the user selects in the list of Minor League team names (hereinafter, referred to as desired Minor League team exclusive facility) to the data read/write device via the data read-out control section 16. Based on the read-out request, the data read-out control section 16 reads out sport team exclusive facility data regarding a desired Minor League team exclusive facility from the navigation DB in the storage device 12, and stores the read out sport team exclusive facility data in the buffer 18.

The facility information drawing section 21 acquires sport team exclusive facility data regarding a desired Minor League team exclusive facility stored in the buffer 18 so that based on the acquired sport team exclusive facility data, the facility information drawing section 21 creates drawing data for displaying the information of a desired Minor League team exclusive facility (hereinafter, referred to as desired Minor team exclusive facility information drawing data), and outputs it to the display processing section 14. It is preferable that the desired Minor League team exclusive facility information drawing data is capable of displaying at least one of address and peripheral map together with the facility name of the desired Minor League team exclusive facility.

The display processing section 14 displays information of the desired Minor League team exclusive facility on the display 8 based on the desired Minor League team exclusive facility information drawing data output from the facility information drawing section 21.

Note that the above-described list of facility names may be allowed to have the function of an operation screen where the user can select a sport team exclusive facility in the list, and information regarding the sport team exclusive facility that the user selects on the list (facility name, address and peripheral map or the like) may be displayed on the display 8 by the facility information drawing section 21 and the display processing section 14.

Further, in this embodiment, in the case where the user performs a character input operation of a team name corresponding to a desired sport team exclusive facility using the input operation section 5, the facility search control section 15 outputs a read-out request of sport team exclusive facility data corresponding to the team name whose characters were inputted to the data read/write device 3 via the data read-out control section 16. Based on the read-out request, the data read-out control section 16 reads out sport team exclusive facility data corresponding to the team name whose characters were inputted from the navigation DB in the storage device 12, and stores the read out sport team exclusive facility data in the buffer 18.

Then, the facility information drawing section 21 acquires the sport team exclusive facility data stored in the buffer 18 to create drawing data for displaying the information regarding the sport team exclusive facility corresponding to the team name whose characters were inputted, and to output the created drawing data to the display processing section 14. It is preferable that the drawing data is capable of displaying at least one of an address and a peripheral map together with the facility name of the sport team exclusive facility corresponding to the team name whose characters were inputted.

Therefore, in this embodiment, desired sport team exclusive facilities may be searched for based on the character input of a team name, and the information can be displayed on the display 8.

In this embodiment, in the case where the user performs the character input operation of the facility name of a desired sport team exclusive facility using the input operation section 5, the facility search control section 15 outputs a read-out request of sport team exclusive facility data corresponding to a facility name whose characters were inputted to the data read/write device via the data read-out control section 16. Based on the read-out request, the data read-out control section 16 reads out sport team exclusive facility data corresponding to the facility name whose characters were inputted from the navigation DB in the storage device 12, and stores the read out sport team exclusive facility data in the buffer 18.

Then, the facility information drawing section 21 acquires the sport team exclusive facility data stored in the buffer 18 to create drawing data for displaying the information regarding the sport team exclusive facility corresponding to the facility name whose characters were inputted, and outputs it to the display processing section 14. Meanwhile, it is preferable that the drawing data is capable of displaying at least one of address and peripheral map together with the facility name whose characters were inputted.

Therefore, in the case where the user knows a current official facility name, the desired sport team exclusive facility is searched for and the information is displayed on the display 8 based on the character input of a facility name.

In addition to the above-described configuration, the navigation DB may store data of a plurality of facility names regarding the same sport team exclusive facility as the sport team exclusive facility data. Specifically, the navigation DB may store not only the current official facility name regarding the same sport team exclusive facility, but also the old name, the commonly used name, or the abbreviated name of the facility name, if necessary. The navigation DB may include information regarding that date the name a facility changed and a new name of a facility, as well as information from present to several years ahead regarding the facility name of sport team exclusive facility (hereinafter, referred to as facility name change information). In some implementations, the facility name change information can be acquired once per year during an annual update of the navigation DB. The annual update of the navigation DB is realized by writing the action of writing data from the data read-out/write device 3 to the storage device 12.

The list drawing section 19 and the display processing section 14 can display an old name, an abbreviated name, a commonly used name or the like, for example, as a plurality of facility names regarding the same sport team exclusive facility in addition to the current official name in the list of facility names based upon the sport team exclusive facility data.

When a facility is easily recognized to users based on information other than a current official name of the facility, the exclusive facility can be searched more easily by displaying a name other than the official name of the facility (old name, abbreviated name, commonly used name or the like), so that desired sport team exclusive facility can be more easily searched. The device may be configured such that an operation screen used for selecting whether or not a plurality of facility names regarding one sport team exclusive facility should be displayed is displayed on the display 8, and a plurality of facility names is displayed after waiting for an input operation to the operation screen.

Based on facility name change information, searching of a sport team exclusive facility can be performed by using a facility name without needing an annual update of the navigation DB after the date that the name of sport team exclusive facility has changed. Specifically, the list drawing section 19 and the display processing section 14 can display the facility name after the change of the name of the facility as a default in the list of facility names by using facility name change information after the date that the facility name changed. Further, in the case where the characters of the facility name after the change were inputted, the facility search control section 15 can display the information of sport team exclusive facility corresponding to the facility name after the change on the display 8 based on the facility name change information by reading out sport team exclusive facility data corresponding to the facility name whose characters were inputted from the navigation DB and allowing the facility information drawing section 21 to acquire it after the date that the facility name has changed.

The facility search control section 15, even in the case where the characters of a facility name before the change were inputted but after changing the facility name, accepts searching of a sport team exclusive facility based on the facility name before the change by reading out sport team exclusive facility data corresponding to the facility name before the change from the navigation DB and allowing the facility information drawing section 21 to acquire the data.

Other than the above-described configurations, the navigation main unit 2 has various configuration sections for navigation. For example, the navigation main unit 2 has a destination setting section 22, which is connected to the input operation section 5. The destination setting section 22 acquires a result of the user's input operation to a final setting screen for setting a destination from the input operation section 5, and sets a destination in response to the acquired result of input operation.

The navigation main unit 2 has a vehicle position calculating section 23, and the GPS receiver 6 and the dead reckoning sensor 7 are severally connected to the input ports of the vehicle position calculating section 23.

The GPS receiver 6 outputs information including orbit and time received from a GPS satellite to the vehicle position calculating section 23. The vehicle position calculating section 23 calculates a vehicle position (absolute position) based on the information outputted from the GPS receiver 6 (electric navigation).

The dead reckoning sensor 7 detects the angular velocity, speed, or the like of a vehicle, and outputs the detection result to the vehicle position calculating section 23. The vehicle position calculating section 23 calculates a vehicle position (relative position) based on the detection result outputted from the dead reckoning sensor 7 (autonomous navigation).

The vehicle position calculating section 23, in the case where the computed vehicle position is not on a road in map data, performs a map matching process for correcting a vehicle position to a position of appropriate road on the map data.

The calculation result of the vehicle position calculating section 23 is inputted to the data read-out control section 16. Then, the data read-out control section 16 outputs the read-out requests of a vehicle position calculated by the vehicle position calculating section 23 and its peripheral map data to the data read-out/write device 3. Further, the data read-out control section 16 outputs the read-out requests of a point specified by the operation of the input operation section 5 and its peripheral map data to the data read-out/write device 3. Then, the data read-out/write device 3 reads out map data in response to the read-out request of the data read-out control section 16 from the storage device 12. A map drawing section 26 is connected to the buffer 18, and map data saved in the buffer 18 is inputted to the map drawing section 26. Then, the map drawing section 26, based on map data inputted from the buffer 18, creates map drawing data for displaying the map image of vehicle position and its periphery or the map image of a point specified by user and its periphery by the operation of the input operation section 5, and outputs it to the display processing section 14. The display processing section 14 displays a map image on the display 8 based on the map drawing data inputted from the map drawing section 26.

A vehicle position drawing section 27 is connected between the vehicle position calculating section 23 and the display processing section 14, and the information of a vehicle position calculated by the vehicle position calculating section 23 is inputted to the vehicle position drawing section 27. The vehicle position drawing section 27 creates vehicle position drawing data for displaying the mark of a vehicle position based on the information of the vehicle position inputted from vehicle position calculating section 23. The vehicle position drawing data created by the vehicle position drawing section 27 is inputted to the display processing section 14. Then, based on the inputted vehicle position drawing data, the display processing section 14 displays the mark of the vehicle position on a map image displayed on the display screen of the display 8 in a superposed manner.

A route calculating section 28 is connected to the output port of the destination setting section 22, the vehicle position calculating section 23, and the buffer 18, and the input port of the data read-out control section 16. The route calculating section 28 performs route calculation for computing a recommended route from a vehicle position, calculated by the vehicle position calculating section 23, to a destination set by the destination setting section 22. The route calculating section 28 allows the data read-out/write device 3 to read out route calculation data (road network data or the like) from the navigation DB via the data read-out control section 16 when calculating route, and uses the read-out route calculation data in route calculation.

A guidance image drawing section 29 is connected to the output port of the route calculating section 28 and buffer 18, and the input port of the display processing section 14. The guidance image drawing section 29 creates guidance image drawing data for displaying a guidance image such as the image of a recommended route and an enlarged intersection image based on the recommended route computed by the route calculating section 28. The map data stored in the buffer 18 is used for creating the guidance image drawing data, if necessary.

A voice guiding section 30 is connected to the output port of the route calculating section 28, and the above-described speaker 9 is connected to the output port of the voice guiding section 30. The voice guiding section 30 creates guidance voice data for performing voice guidance such as intersection right/left turn guidance based on the recommended route computed by the route calculating section 28, and outputs the created guidance voice data to the speaker 9. The speaker 9 outputs the sound of the voice data created by the voice guiding section 30.

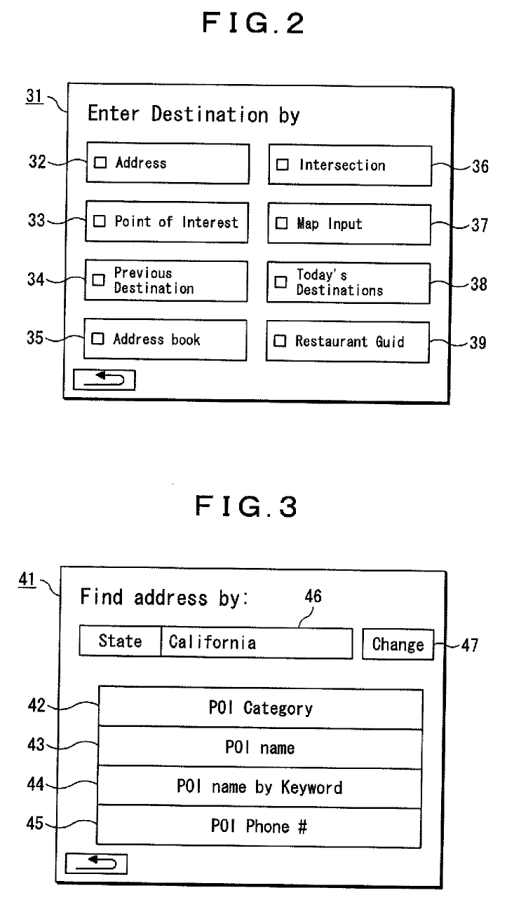

Next, description will be made for the main operation of this embodiment using more specific examples. The operation screen drawing section 10 and the display processing section 14 display a first operation screen for searching a facility 31 on the display 8 first as shown in FIG. 2. The first operation screen for searching a facility 31 includes operation buttons (32 to 39) for selecting each item to perform setting of a destination based on various items.

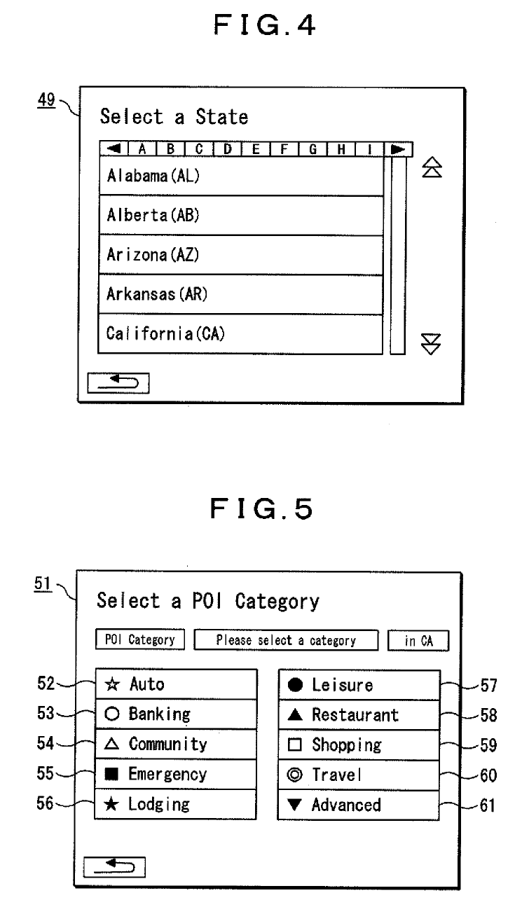

Next, when the user operates an operation button 33 for selecting a POI (Points of Interest) on the first operation screen 31 for searching a facility by using the input operation section 5, the operation screen drawing section 10 and the display processing section 14 display a second operation screen 41 for searching a facility on the display 8 as shown in FIG. 3. The second operation screen 41 for searching a facility includes an operation button 42 for allowing the user to input a POI category, an operation button 43 for allowing the user to select a POI name, an operation button 44 for allowing the user to input the character of a POI name, and an operation button 45 for allowing the user to input a telephone number of a POI. Further, the second operation screen 41 for searching a facility includes an input screen 46 for selecting and inputting a state in the U.S. as address. A change button 47 for changing the inputted state is displayed beside the input screen 46, and when the change button 47 is operated, a third operation screen 49 for searching a facility on which a candidate of states, as shown in FIG. 4, can be selected is displayed. Then, in the case where a new state is selected in the third operation screen 49 for searching a facility, the new state is displayed on the input screen 46 in the second operation screen 41 for searching a facility.

When the user operates the operation button 42 for allowing the user to input a POI category in the second operation screen 41 for searching a facility using the input operation section 5, the operation screen drawing section 10 and the display processing section 14 display a fourth operation screen 51 for searching a facility on the display 8 as shown in FIG. 5. The fourth operation screen 51 for searching a facility is a first step input screen for selecting and inputting a POI category from a plurality of candidates, and the operation screen 51 includes operation buttons (52 to 61) for selecting various categories such as bank, recreation facility and restaurant as POI categories.

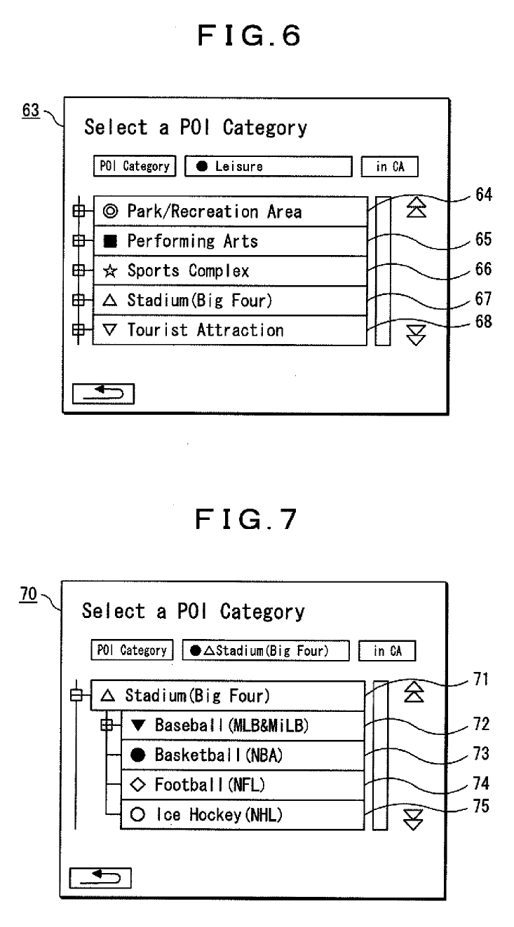

Next, when the user operates an operation button 57 for selecting a recreation facility by using the input operation section 5 on the fourth operation screen 51 for searching a facility, the operation screen drawing section 10 and the display processing section 14 display a fifth operation screen 63 for searching a facility on the display 8 as shown in FIG. 6. The fifth operation screen 63 for searching a facility is a second step input screen for selecting and inputting a POI category from a plurality of candidates, and the fifth operation screen 63 for searching a facility includes operation buttons (64 to 68) for selecting one category from a plurality of categories of recreation facilities.

Next, when the user operates an operation button 67 for selecting a stadium of the U.S. big four sports in the fifth operation screen 63 for searching for a facility using the input operation section 5, the operation screen drawing section 10 and the display processing section 14 display a sixth operation screen 70 for searching for a facility on the display 8 as shown in FIG. 7. The sixth operation screen 70 for searching a facility is an input screen for selecting and inputting a professional sport category, and the operation screen 70 includes an operation button 71 for selecting a baseball stadium, an operation button 72 for selecting a basketball stadium, an operation button 73 for selecting an American football stadium, and an operation button 74 for selecting an ice hockey stadium.

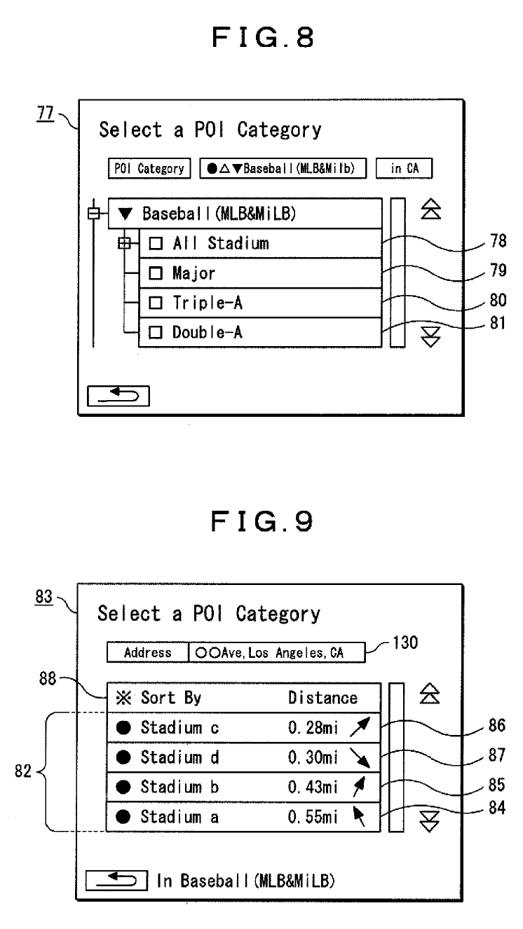

Next, when the user operates an operation button 71 for selecting a baseball stadium to the sixth operation screen 70 for searching for a facility using the input operation section 5, the operation screen drawing section 10 and the display processing section 14 display a seventh operation screen 77 for searching a facility on the display 8 as shown in FIG. 8. The seventh operation screen 77 for searching a facility is a second step input screen on which a professional sport team category can be selected and inputted. In other words, the seventh operation screen 77 for searching a facility includes an operation button 78 for selecting all baseball stadiums, an operation button 79 for selecting a Major League (MLB) stadium, an operation button 80 for selecting a Tripple-A Minor League stadium (MLB), and an operation button 81 for selecting a Double-A Minor League stadium. Meanwhile, only baseball out of the U.S. big four sports currently has affiliated professional leagues, and in this embodiment, selection and input of a professional sport category is not performed in two steps for the three sports other than baseball. Further, on the seventh operation screen 77 for searching a facility, an operation button for selecting another Minor League such as A-Advanced, A and Rookie League may be displayed.

Next, when the user operates an operation button 79 for selecting a Major League stadium to the seventh operation screen 77 for searching a facility using the input operation section 5, the list drawing section 19 and the display processing section 14 display a first stadium name list display screen 83 including a list 82 of Major League stadium names as a list of facility names on the display 8 as shown in FIG. 9. On the first stadium name list display screen 83, a plurality of stadium names (stadiums a to d) in the list 82 is displayed in the state where the information of required travel distance from the vehicle position to the stadium and the direction of stadium are shown beside them. Further, each stadium name in the list 82 may be displayed as operation buttons (84 to 87) selectable by the operation of the input operation section 5. Moreover, stadium names in the list 82 may be listed from ones having smaller required travel distance from the vehicle position to the stadium (miles). Furthermore, the first stadium name list display screen 83 displays a sorting/switching operation button 88 for allowing the user to display the sorted list or to switch the display associated with the sorted list. Moreover, the first stadium name list display screen 83 includes a screen 130 that displays the address of a stadium displayed on the top of the list 82.

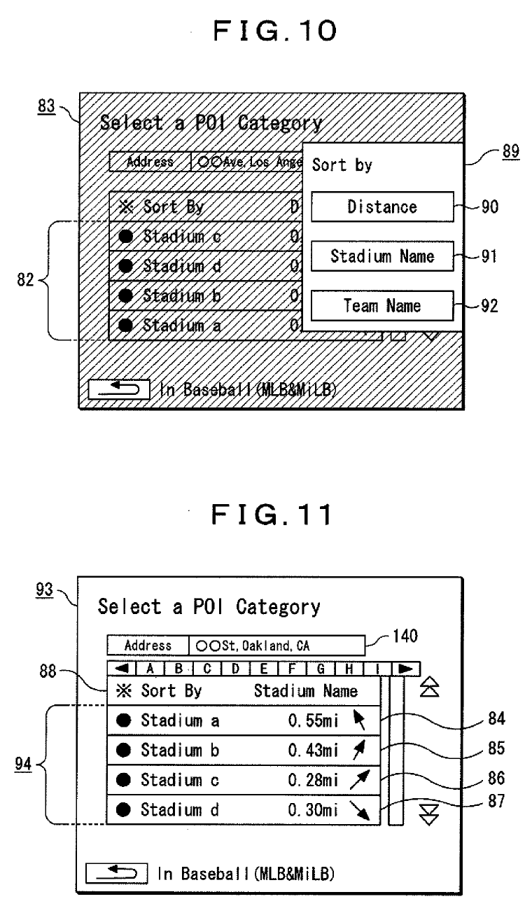

Next, when the user operates a sorting/switching operation button 88 to the first stadium name list display screen 83 using the input operation section 5, the list drawing section 19 and the display processing section 14 display the sort/switch item selection screen 89 on the first stadium name list display screen 83 displayed on the display 8 as shown in FIG. 10. The sort/switch item selection screen 89 includes a distance selection button 90 for selecting to sort stadium names from smaller required travel distance to stadium, a stadium name selection button 91 for selecting to sort stadium names by alphabetical order, and a team name selection button 92 for selecting to switch display to a team name corresponding to each stadium name in the list 82 and to arrange team names in alphabetical order.

Next, when the user selects and operates a stadium name selection button 91 on the sort/switch item selection screen 89 using the input operation section 5, the list drawing section 19 and the display processing section 14 display a second stadium name list display screen 93 on the display 8 as shown in FIG. 11. The second stadium name list display screen 93 displays, similar to the first stadium name list display screen 83, a plurality of stadium names (stadium a to d) in the stadium name list 94 in the state where required travel distance from the vehicle position to the stadium and the information of the direction of stadium are shown beside them. Further, each stadium name in the list 94 is displayed as an operation button (84 to 87) that can be selected by the operation of the input operation section 5. Moreover, the second stadium name list display screen 93 displays the sorting/switching operation button 88 for transiting to the sort/switch item selection screen 89. However, in the second stadium name list display screen 93, unlike the first stadium name list display screen 83, each stadium name in the list 94 is sorted in alphabetical order. Further, on the sorting/switching operation button 88, the fact that search result is arranged in the order of stadium names is written. Moreover, the second stadium name list display screen 93 includes a screen 140 that displays the address of a stadium displayed at the top of the list 94.

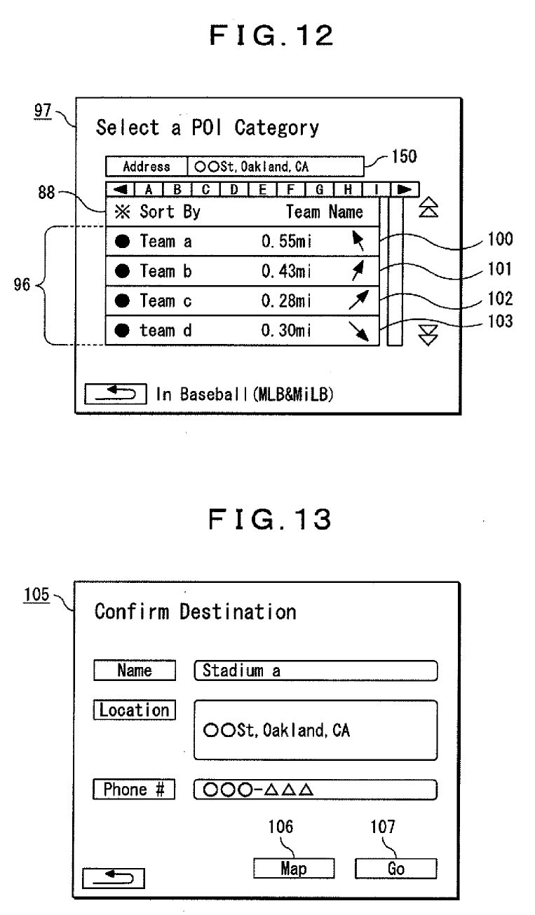

Next, when the user sequentially operates sorting/switching operation button 88 in the second stadium name list display screen 93 and a team name selection button 92 (not shown in FIG. 11) on the sort/switch item selection screen 89 using the input operation section 5, the list drawing section 19 and the display processing section 14 display a team name list display screen 97 on the display 8 as shown in FIG. 12.

The team name list display screen 97 includes the list 96 of team names corresponding to each stadium name displayed on the list 82 of stadium names, and a plurality of team names in the list 96 (teams a to d) is displayed in alphabetical order in the state where the information of required travel distance from the vehicle position to the stadium and the direction of stadium are shown beside them.

Further, each team name in the list 96 is displayed as operation buttons 100 to 103 that can be selected by the input operation section 5. Moreover, the team name list display screen 97 displays the sorting/switching operation button 88, and by sequentially operating the sorting/switching operation button 88 and the stadium name selection button 91 (not shown in FIG. 12) on the sort/switch item selection screen 89, the user can return to the second stadium name list display screen 93.

Herein, since the information of required travel distance and direction are shown beside both of each stadium name in the list 94 on the second stadium name list display screen 93 and each team name in the list 96 on the team name list display screen 97, based on the information, the corresponding relation between each stadium name and each team name can be easily grasped. For example, FIG. 11 and FIG. 12 show that an exclusive stadium that team ‘a’ uses as home is stadium a.

Therefore, the user can perform searching of a desired stadium based on a team name by switching the display on the second stadium name list display screen 93 and the display on the team name list display screen 97.

As described, after the user searches for the stadium name of a desired stadium, when the user selects and operates the operation buttons 84 to 87 of a desired stadium name on the second stadium name list display screen 93 using the input operation section 5, the facility information drawing section 21 and the display processing section 14 display a destination confirmation screen 105 on the display 8 as shown in FIG. 13. The destination confirmation screen 105 displays a stadium name, location (address), and telephone number as the information of the desired stadium that the user selected. Further, the destination confirmation screen 105 displays a map display button 106, and based on operating the map display button 106 by the input operation section 5, a peripheral map of the desired stadium can be displayed. Note that the peripheral map, the facility name, and the address may be displayed on the same screen. Moreover, the destination confirmation screen 105 displays a destination decision button 107, and based on operating the destination decision button 107 by the input operation section 5, a stadium displayed on the destination confirmation screen 105 can be set as a navigation destination. In other words, the destination confirmation screen 105 becomes an operation screen for finally setting a destination.

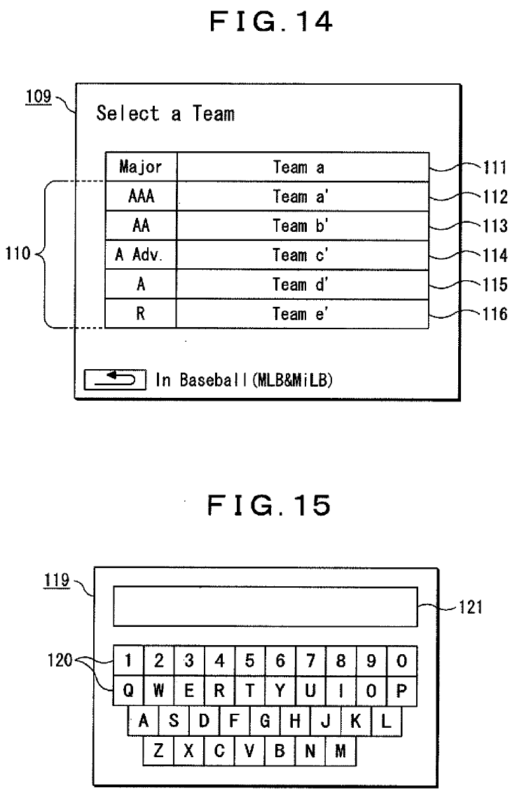

Incidentally, when the user selects and operates operation buttons 100 to 103 of a desired team name to the team name list display screen 97 using the input operation section 5, the list drawing section 19 and the display processing section 14 display an MLB team name list display screen 109 on the display 8 as shown in FIG. 14. The MLB team name list display screen 109 displays a team name list 110 of Minor League teams affiliated with a Major League team, which the user selected on the team name list display screen 97, together with the team name of the Major League team. Further, each team name is displayed as operation buttons 111 to 116 that can be selected by the input operation section 5.

Next, when the user operates an operation button 112 for selecting a Tripple-A team (team a′) in the MLB team name list display screen 109 using the input operation section 5, for example, the facility information drawing section 21 and the display processing section 14 display the destination confirmation screen 105 similar to FIG. 13 on the display 8. Although not shown, the destination confirmation screen 105 displays the exclusive stadium name of the Tripple-A team, which the user selected, together with the location or the like.

Thus, the user can search an exclusive stadium that a desired Minor League team uses as home.

Further, returning to FIG. 3, when the user operates the operation button 44 for allowing the user to input the character of a POI name in the second operation screen 41 for searching for a facility using the input operation section 5, the operation screen drawing section 10 and the display processing section 14 display a character input screen 119 on the display 8 as shown in FIG. 15. The character input screen 119 is made up of input keys 120 and a confirmation screen 121.

When the user inputs a desired stadium name in the character input screen 119 using the input keys 120 and the input operation section 5, the facility information drawing section 21 and the display processing section 14 display a destination confirmation screen 105, which displays a stadium name whose characters were inputted together with its location or the like, on the display 8. Further, when the user inputs the team name of a desired baseball team in the character input screen 119 using the input operation section 5, the facility information drawing section 21 and the display processing section 14 display a destination confirmation screen 105 showing a stadium name corresponding to the team name whose characters were inputted on the display 8 together with its location or the like.

Meanwhile, in the case of searching a team name by character input, there is a possibility that a facility other than a stadium is detected as the exclusive facility of the team. Therefore, in such a case, an operation screen for limiting a plurality of exclusive facilities to stadiums is displayed, and a destination confirmation screen 105 may be displayed after a stadium is selected on the operation screen.

Thus, the user can search a desired stadium by character input.

As described above, according to this embodiment, since an exclusive facility for a professional sport team can be searched based on a team name, a desired sport team exclusive facility can be searched for regardless of a change of name of the facility.

It should be appreciated that a sport team exclusive facility should not be limited to a stadium. For example, a sport team exclusive facility may also be a facility where a camp is conducted.

Next, a second embodiment of the facility search device is described, focusing on differences from the first embodiment. The facility search device in this embodiment is formed so as to be capable of searching for a desired facility regardless of a change of a facility name similar to the first embodiment, and its basic configuration is the same as the first embodiment. However, a subject to be searched in this embodiment is not an exclusive facility for a professional sport team as in the first embodiment, but is an exclusive facility for live performance groups.

In this embodiment, the input operation section 5 functions as a type input device, and when the user searches an exclusive facility for a desired live performance group (hereinafter, abbreviated as live performance group exclusive facility), he/she can perform an input operation of performance content type and facility type as a search condition using the input operation section 5. Examples of performance content type include, opera, play, music performance or the like. Examples of facilities types include, theater, concert hall or the like. The input of these types may be performed to the operation screen 51, 63 for searching a facility or the like shown in FIG. 5 and FIG. 6, for example.

Further, the input operation section 5 functions as an address input device, and when the user searches for a desired live performance group exclusive facility using the input operation section 5, he/she can perform an input operation of address as a search condition. The input operation of an address may be performed using the operation screen 41 to search for a facility as shown in FIG. 3, for example.

Moreover, the input operation section 5 functions as a group name characters input device so that when the user searches for a desired live performance group exclusive facility, he/she can perform a character input operation of a group name corresponding to the desired live performance group exclusive facility as a search condition using the input operation section 5. The character input operation of the group name may be performed in the character input screen shown in FIG. 15, for example.

Furthermore, the input operation section 5 functions as a facility name characters input device so that when the user searches for a desired live performance group exclusive facility, he/she can perform the character input operation of the facility name of the desired live performance group exclusive facility as a search condition using the input operation section 5. The character input operation of the facility name may be performed using the character input screen shown in FIG. 15, for example.

In this embodiment, the navigation DB stores data regarding live performance group exclusive facility (hereinafter, referred to as live performance group exclusive facility data). The navigation DB may store data such as a facility name, a group name, address, the type of a facility, the type of performance contents, or the like, regarding live performance group exclusive facility, for example, in the state of having corresponding relation with each other.

Further, in this embodiment, the operation screen drawing section 10 creates the drawing data of various operation screens such as an operation screen for searching for a facility to search for a desired live performance group exclusive facility, and outputs the created drawing data to the display processing section 14. The display processing section 14 displays an operation screen corresponding to the drawing data outputted from the operation screen drawing section 10 on the display 8.

Moreover, in this embodiment, the facility search control section 15 outputs a read-out request of live performance group exclusive facility data of live performance group exclusive facility satisfying the search condition inputted by using the input operation section 5 (hereinafter, referred to as appropriate live performance group exclusive facility) to the data read-out/write device 3. Meanwhile, there are cases where the input operation of said search condition is performed for plural times by sequentially using a plurality of operation screens for searching a facility. Further, there are cases where a plurality of appropriate live performance group exclusive facility exists.

By the read-out request, the data read-out/write device 3 reads out live performance group exclusive facility data regarding appropriate live performance group exclusive facility (hereinafter, referred to as appropriate live performance group exclusive facility data) from the navigation DB stored in the storage device 12.

Then, the data read-out/write device 3 temporarily stores the read out appropriate live performance group exclusive facility data into the buffer 18 connected to the data read-out/write device 3.

In this embodiment, the list drawing section 19, together with the display processing section 14 and the facility search control section 15, functions as a live performance facility name list display processing device, a group name list display processing device, and a display switching step device.

In other words, the facility search control section 15 reads out appropriate live performance group exclusive facility data that satisfies at least one condition of the type of a facility, the type of performance contents, and address which are the search condition inputted by using the input operation section 5, from the navigation DB via the data read-out control section 16 and the data read-out/write device 3, and stores the read out appropriate live performance group exclusive facility data in the buffer 18.

Moreover, the list drawing section 19 acquires the appropriate live performance group exclusive facility data stored in the buffer 18, and using the acquired appropriate live performance group exclusive facility data, selectively creates drawing data for displaying the list of facility names of appropriate live performance group exclusive facility (hereinafter, referred to as facility name list drawing data) or drawing data for displaying the list of group names corresponding to appropriate live performance group exclusive facility (hereinafter, referred to as group name list drawing data) in the state where corresponding relation with a facility name is distinguishable. The facility name list drawing data or the group name list drawing data created by the list drawing section 19 is outputted to the display processing section 14.

Then, the display processing section 14 selectively performs a display process of the list of facility names on the display 8 using the facility name list drawing data or a display process of the group name list on the display 8 using the group name list drawing data.

Meanwhile, selection of whether the list of facility names or the list of group names should be displayed is determined based on displaying an operation screen on which the selection can be performed (for example, a sort/switch item selection screen 204 to be described later (refer to FIG. 17)) and on the input operation (selection) of the user to the operation screen.

Thus, the list of facility names or the list of group names is displayed on the display 8 in the state where the corresponding relation between a facility name and a group name is distinguishable by display switching between both lists. Specifically, in both the list of facility names and the list of group names, the corresponding relation between a facility name and a group name may be distinguishable by showing the distance and the direction to a facility beside the facility name or the group name. Alternatively, facility names in the list of facility names and group names in the list of group names may be displayed in the same order. With this method, the user can easily distinguish the corresponding relation between a facility name and a group name based on alternately seeing the both lists by switching the display.

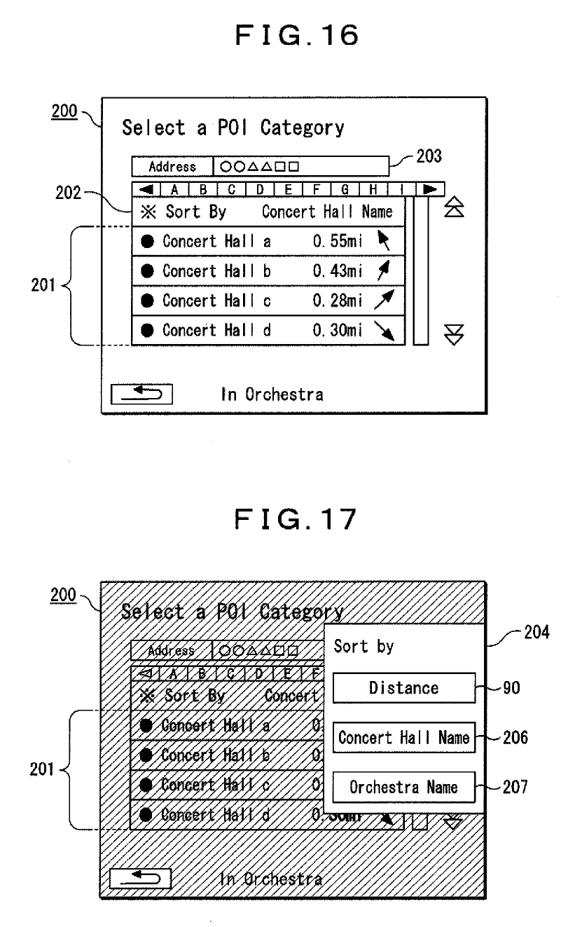

Herein, as the display of a facility name list in this embodiment, a concert hall name list display screen 200 as shown in FIG. 16 may be displayed, for example. The concert hall name list display screen 200 includes a concert hall name list 201 of concert halls as the list of facility names of live performance group exclusive facility. A plurality of concert hall names in the list 201 (concert halls a to d) is displayed in alphabetical order in the state where required travel distance from a vehicle position to a concert hall and the direction of the concert hall are shown beside them. Further, the concert hall name list display screen 200 displays a display screen 203 displaying the address of a concert hall corresponding to a concert hall name listed at the top of the list 201. Moreover, the concert hall name list display screen 200 displays the sorting/switching operation button 202 in a selectable state by the operation of the input operation section 5, and the fact that search results are listed in the order of concert hall names is written on the sorting/switching operation button 202.

Then, when the user operates the sorting/switching operation button 202, the sort/switch item selection screen 204 is displayed on the concert hall name list display screen 200 as shown in FIG. 17. The sort/switch item selection screen 204 includes the distance selection button 90, a concert hall name selection button 206 for selecting to arrange concert hall names in alphabetical order, and an orchestra name selection button 207 for selecting to switch display into orchestra names as group names corresponding to each concert hall name in the list 201 and to arrange the orchestra names in alphabetical order.

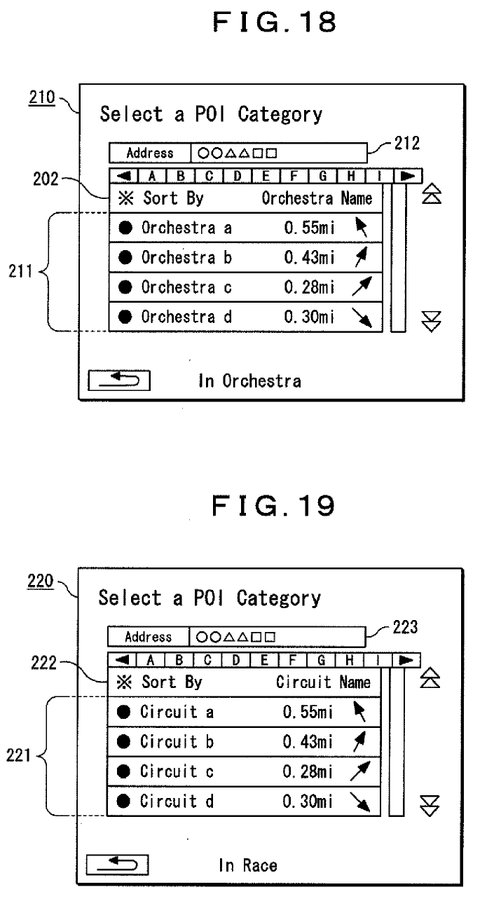

Moreover, when the user selects and operates the orchestra name selection button 207 in the sort/switch item selection screen 204 using the input operation section 5, an orchestra name list display screen 210 is displayed as shown in FIG. 18. The orchestra name list display screen 210 includes a list 211 of orchestra names corresponding to each concert hall name displayed in the concert hall name list 201. Each orchestra name in the list 211 may be displayed in alphabetical order in the state where required travel distance from a vehicle position to a concert hall and direction of the concert hall are shown beside them. Further, the orchestra name list display screen 210 displays a display screen 212 of the address of a concert hall corresponding to an orchestra name listed at the top of the list 211. Moreover, the orchestra name list display screen 210 displays the sorting/switching operation button 202, and by sequentially operating the sorting/switching operation button 202 and the concert hall name selection button 206 on the sort/switch item selection screen 204 (not shown in FIG. 18), the user can return to the concert hall name list display screen 200.

According to the examples shown in FIG. 16 to FIG. 18, the user, by comparing the concert hall name list display screen 200 with the orchestra name list display screen 210, can easily distinguish the exclusive concert hall of orchestra ‘a’ is concert hall ‘a’, for example, and can securely search desired concert hall ‘a’ based on the orchestra name.

Therefore, according to this embodiment, the user can search desired live performance group exclusive facility by switching display of the facility name list and the group name list.

Moreover, in this embodiment, the facility information drawing section 21, together with the display processing section 14 and the facility search control section 15, functions as a facility information display processing device.

In other words, the facility search control section 15, in the case where the user performed the character input operation of a group name corresponding to desired live performance group exclusive facility by using the input operation section 5, outputs the read-out request of live performance group exclusive facility data corresponding to the group name whose characters were inputted to the data read/write device 3 via the data read-out control section 16. By the read-out request, the data read-out control section 16 reads out live performance group exclusive facility data corresponding to the group name whose characters were inputted from the navigation DB in the storage device 12, and stores the read out live performance group exclusive facility data in the buffer 18.

Then, the facility information drawing section 21 acquires the live performance group exclusive facility data stored in the buffer 18, and by using the acquired live performance group exclusive facility data, creates drawing data for displaying the information of live performance group exclusive facility corresponding to the group name whose characters were inputted, and outputs it to the display processing section 14. Meanwhile, it is preferable that the drawing data be capable of displaying at least one of address and the peripheral map together with the facility name of live performance group exclusive facility corresponding to the group name whose characters were inputted.

Therefore, in this embodiment, desired live performance group exclusive facility can be searched by the character input of a group name, and the information can be displayed on the display 8. Herein, as the information of live performance group exclusive facility, a screen similar to the destination confirmation screen 105 in the first embodiment may be displayed, for example. However, unlike the first embodiment, the destination confirmation screen displays the facility name of the live performance group exclusive facility together with address or the map display button 106.

Moreover, in this embodiment, the facility search control section 15, in the case where the user performed the character input operation of the facility name of desired live performance group exclusive facility using the input operation section 5, outputs a read-out request of live performance group exclusive facility data corresponding to the facility name whose characters were inputted to the data read/write device 3 via the data read-out control section 16. Based on the read-out request, the data read-out control section 16 reads out live performance group exclusive facility data corresponding to the facility name whose characters were inputted from the navigation DB in the storage device 12, and stores the read out live performance group exclusive facility data in the buffer 18.

Then, the facility information drawing section 21 acquires the live performance group exclusive facility data stored in the buffer 18, and by using the acquired live performance group exclusive facility data, creates drawing data for displaying the information of live performance group exclusive facility corresponding to the facility name whose characters were inputted, and outputs it to the display processing section 14. It is preferable that the drawing data be capable of displaying at least one of address and the peripheral map together with the facility name whose characters were inputted.

Therefore, in the case where the user knows a current official facility name, he/she may search for a desired live performance group exclusive facility by the character input of a facility name, and can display the information on the display 8.

In addition to the above-described configuration, in this embodiment, the navigation DB may store data of a plurality of facility names regarding the same live performance group exclusive facility as the live performance group exclusive facility data. Specifically, the navigation DB stores not only the current official facility name, but also the old name, the commonly used name, or the abbreviated name of the facility name regarding the same live performance group exclusive facility, if necessary. Moreover, the navigation DB includes the information of a date a name of facility will change and a name of the facility after change (hereinafter, referred to as facility name change information) from present to several years ahead regarding the facility name of live performance group exclusive facility. In one implementation, the facility name change information can be acquired one a year in an annual update of the navigation DB.

Using live performance group exclusive facility data, the list drawing section 19 and the display processing section 14 can display the old name, the abbreviated name, the commonly used name or the like, for example, on the list of facility names in addition to the current official name as a plurality of facility names regarding the same live performance group exclusive facility.

Therefore, regarding a facility that is recognized by users with a name other than a current official name, the exclusive facility can be searched more easily by displaying a name other than the official name (old name, abbreviated name, commonly used name or the like), so that desired live performance group exclusive facility can be further searched.

Moreover, in this embodiment, by using facility name change information, after the date a name of a live performance group facility has changed, searching of a live performance group exclusive facility can be performed using the facility name after the change without the need of annual update of the navigation DB.

Furthermore, in this embodiment, the facility search control section 15 accepts searching of a live performance group exclusive facility after changing the facility name using the facility name before the change even in the case where the characters of the facility name before the change were inputted

As described above, according to this embodiment, since live performance group exclusive facility can be searched based on a group name, desired live performance group exclusive facility can be searched regardless of the change of name due to the influence or the like of naming rights business.

Next, a third embodiment of the facility search device is described, focusing on differences from the first embodiment. The facility search device in this embodiment is formed to be capable of searching a desired facility regardless of the change of facility name, similar to the first embodiment, and the basic configuration is the same as the first embodiment. However, it is assumed that the subject to be searched in this embodiment is an event holding facility instead of an exclusive facility for a professional sport team in the first embodiment.

In this embodiment, the input operation section 5 functions as a type of input device that a user uses to perform the input operation of an event type and the a facility type as a search condition in searching a facility holding a desired event (hereinafter, abbreviated as event holding facility) using the input operation section 5. As an event type, a sport event such as motor sport, a university American football championship, a horse race, sumo wrestling, or the like can be given. As a facility type, a racing circuit, a gymnasium, a national sport stadium, or the like can be given, for example. The input of these types may be performed to the operation screens 51, 63 for searching a facility as shown in FIG. 5 and FIG. 6, for example.

Further, the input operation section 5 functions as an address input device, and the user can perform the input operation of address as a search condition in searching a desired event holding facility by using the input operation section 5. The input operation of address may be performed to the operation screen 41 for searching a facility shown in FIG. 3, for example.

Moreover, the input operation section 5 functions as an event name characters input device, and the user can perform the character input operation of an event name corresponding to desired event holding facility as a search condition in searching a desired event holding facility by using the input operation section 5. The character input operation of the event name may be performed with a character input screen shown in FIG. 15, for example. Further, as an event name, the event name of the above-described each sport event can be given.

Furthermore, the input operation section 5 functions as a facility name characters input device that a user can use to perform the character input operation of the facility name of desired event holding facility as a search condition in searching a desired event holding facility by using the input operation section 5. The character input operation of the facility name may be performed with the character input screen shown in FIG. 15, for example.

In this embodiment, the navigation DB stores data regarding an event holding facility (hereinafter, referred to as event holding facility data). For example, the navigation DB may store data such as the facility name, the event name, the address, the facility type, the event type, or the like, regarding the event holding facility in the state of having relation corresponding with each other.

Further, in this embodiment, the operation screen drawing section 10 creates the drawing data of various operation screens such as an operation screen for searching a facility to search desired event holding facility, and outputs the created drawing data to the display processing section 14. The display processing section 14 displays an operation screen corresponding to the drawing data outputted from the operation screen drawing section 10 on the display 8.

Moreover, in this embodiment, the facility search control section 15 outputs a read-out request of event holding facility data of event holding facility satisfying the search condition inputted by using the input operation section 5 (hereinafter, referred to as appropriate event holding facility) to the data read-out/write device 3. Meanwhile, there are cases where the input operation of the search condition is performed a plurality of times by sequentially using a plurality of operation screens for searching a facility. Further, there are cases where a plurality of appropriate event holding facilities exist.

Based on the read-out request, the data read-out/write device 3 reads out event holding facility data regarding appropriate event holding facility (hereinafter, referred to as appropriate event holding facility data) from the navigation DB stored in the storage device 12. Then, the data read-out/write device 3 temporarily stores the read out appropriate event holding facility data in the buffer 18 connected to the data read-out/write device 3.

In this embodiment, the list drawing section 19, together with the display processing section 14 and the facility search control section 15, functions as a holding facility name list display processing device, an event name list display processing device, and a display switching step device.

In other words, the facility search control section 15 reads out appropriate event holding facility data satisfying at least one condition of a facility type, an event type, and address as the search condition inputted using the input operation section 5 from the navigation DB via the data read-out control section 16 and the data read-out/write device 3, and stores the read out appropriate event holding facility data in the buffer 18.

Moreover, the list drawing section 19 acquires appropriate event holding facility data stored in the buffer 18, and using the acquired appropriate event holding facility data, selectively creates drawing data for displaying the list of facility names of appropriate event holding facility (hereinafter, referred to as facility name list drawing data) or the list of event names corresponding to appropriate event holding facility (hereinafter, referred to as event name list drawing data) in the state where the relation corresponding with facility name is distinguishable. The facility name list drawing data or the event name list drawing data created by the list drawing section 19 is outputted to the display processing section 14.

Then, the display processing section 14 selectively performs a display process of the list of facility names on the display 8 using facility name list drawing data or a display process of the list of event names on the display 8 using event name list drawing data.

A determination of whether the list of facility names or the list of event names should be displayed is made based on displaying an operation screen on which the selection can be performed (for example, a sort/switch item selection screen 224 to be described later), and on the input operation (selection) of the user in the operation screen.

Thus, the display 8 displays the list of facility names or the list of event names in the state where the corresponding relation between facility names and event names is distinguishable by switching the display between both lists. Specifically, in both of the list of facility names and the list of event names, by showing the distance and the direction to a facility beside the facility name or the event name, the corresponding relation between the facility name and the event name may be distinguishable. Alternatively, facility names in the list of facility names and event names in the list of event names may be displayed in the same order. With this method, the user can easily distinguish the corresponding relation between facility names and event names by alternately seeing the both lists based on switching the display.

Herein, as with the display of a facility name list in this embodiment, a circuit name list display screen 220, as shown in FIG. 19, may be displayed, for example. The circuit name list display screen 220 includes a circuit name list 221 of racing circuits as the list of facility names of event holding facility. A plurality of circuit names in the list 221 (circuits a to d) is displayed in alphabetical order in the state where required travel distance from a vehicle position to a racing circuit and the direction of racing circuit are shown beside them. Further, the circuit name list display screen 220 includes a display screen 223 that displays the address of a racing circuit corresponding to a circuit name listed on the top of the list 221. Moreover, the circuit name list display screen 220 displays a sorting/switching operation button 222 in a selectable state by the operation of the input operation section 5, and the fact that search results are arranged in the order of circuit names is written on the sorting/switching operation button 222.

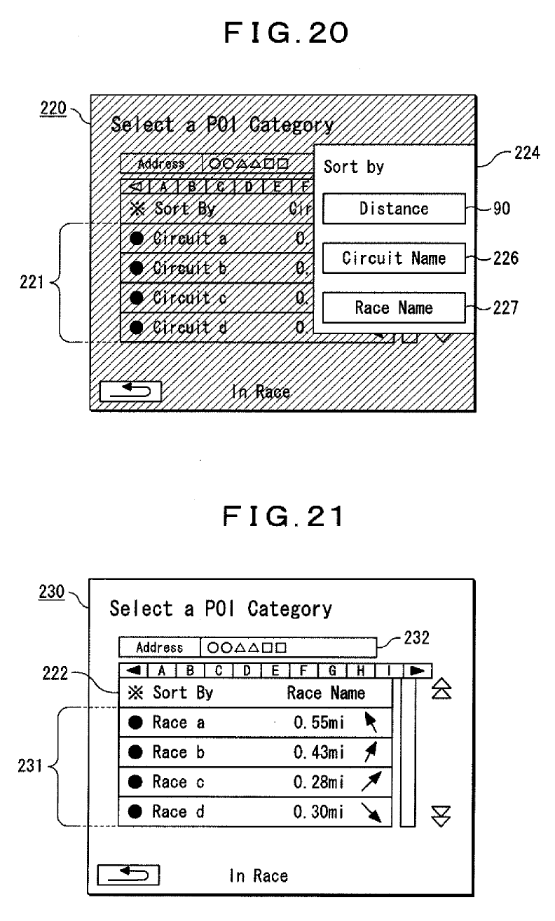

Then, when the user operates the sorting/switching operation button 222, a sort/switch item selection screen 224 is displayed on the circuit name list display screen 220 as shown in FIG. 20. The sort/switch item selection screen 224 includes the distance selection button 90, a circuit name selection button 226 for selecting to arrange circuit names in alphabetical order, and a race name selection button 227 for selecting to switch a display into a race name as an event name corresponding to each circuit name in the list 221 and to arrange race names in alphabetical order.

Moreover, when the user selects and operates the race name selection button 227 on the sort/switch item selection screen 224 by using the input operation section 5, a race name list display screen 230 is displayed, as shown in FIG. 21. The race name list display screen 230 includes a list 231 of race names corresponding to each circuit name displayed on the circuit name list 221 and each race name in the list 231 is displayed in alphabetical order in the state where the required travel distance from a vehicle position to a racing circuit and the direction of racing circuit are shown beside them. Further, the race name list display screen 230 includes a display screen 232 that displays the address of a racing circuit holding a race whose name is listed on the top of the list 231. Moreover, the race name list display screen 230 displays the sorting/switching operation button 222, and the user can return to the circuit name list display screen 220 by sequentially operating the sorting/switching operation button 222 and the circuit name selection button 226 (not shown in FIG. 21) in the sort/switch item selection screen 224.

According to these examples shown in FIG. 19 to FIG. 21, the user, by comparing the circuit name list display screen 220 with the race name list display screen 230, can easily distinguish an exclusive racing circuit holding race ‘a’ is circuit ‘a’, and can securely search desired racing circuit ‘a’ based on the race name, for example.

Therefore, according to this embodiment, the user can search for a desired event holding facility by switching the display of a facility name list and of an event name list.

Moreover, in this embodiment, the facility information drawing section 21, together with the display processing section 14 and the facility search control section 15, functions as a facility information display processing device.

In other words, the facility search control section 1S, in the case where the user performed the character input operation of an event name corresponding to desired event holding facility using the input operation section 5, outputs a read-out request of an event holding facility data corresponding to the event name whose characters were inputted to the data read/write device via the data read-out control section 16. Based on the read-out request, the data read-out control section 16 reads out event holding facility data corresponding to the event name whose characters were inputted from the navigation DB in the storage device 12, and stores the read out event holding facility data in the buffer 18.

Then, the facility information drawing section 21 acquires event holding facility data stored in the buffer 18, and based on the acquired event holding facility data, creates drawing data for displaying the information of an event holding facility corresponding to the event name whose characters were inputted, and outputs it to the display processing section 14. It is preferable that the drawing data is capable of displaying at least one of address and peripheral map together with the facility name of an event holding facility corresponding to the event name whose characters were inputted.

Therefore, in this embodiment, desired event holding facility can be searched for based on the character input of an event name, and the information can be displayed on the display 8. Herein, as with the information of the event holding facility, a screen similar to the destination confirmation screen 105 in the first embodiment may be displayed, for example. However, unlike the first embodiment, the facility name of the event holding facility will be displayed in the destination confirmation screen together with the address and the map display button 106.

The facility search control section 15, in the case where the user performed the character input operation of the facility name of a desired event holding facility using the input operation section 5, outputs a read-out request of event holding facility data corresponding to the facility name whose characters were inputted to the data read/write device via the data read-out control section 16. Based on the read-out request, the data read-out control section 16 reads out event holding facility data corresponding to the facility name whose characters were inputted from the navigation DB in the storage device 12, and stores the read out event holding facility data in the buffer 18.

Then, the facility information drawing section 21 acquires event holding facility data stored in the buffer 18, and based on the acquired event holding facility data, creates drawing data for displaying the information of the event holding facility corresponding to the facility name whose characters were inputted, and outputs it to the display processing section 14. Meanwhile, it is preferable that the drawing data be capable of displaying at least one of address and the peripheral map together with the facility name whose characters were inputted.

Therefore, in the case where the user knows a current official facility name, a desired event holding facility can be searched for based on the character input of the facility name, and its information can be displayed on the display 8.

In addition to the above-described configuration, moreover in this embodiment, the navigation DB stores the data of a plurality of facility names regarding the same event holding facility as event holding facility data. Specifically, regarding the same event holding facility, the navigation DB stores not only the current official facility name, but also the old name, the commonly used name, or the abbreviated name of the facility name, if necessary. Moreover, the navigation DB may include information regarding a date of a change of a name of a facility and the name of a facility after the change (hereinafter, referred to as facility name change information) from a present date to several years ahead in time. In one implementation, the facility name change information can be acquired once a year during an annual update of the navigation DB.

The list drawing section 19 and the display processing section 14 can display old name, abbreviated name, commonly used name, or the like in the list of facility names in addition to the current official name, for example, as a plurality of facility names regarding the same event holding facility using the event holding facility data.

Therefore, regarding a facility that a user recognizes by a name other than the current official name of the facility, the exclusive facility can be searched more easily by displaying a name other than the official name (old name, abbreviated name, commonly used name or the like), so that desired event holding facility can be searched more securely.

Moreover, in this embodiment, by using the facility name change information, after the change date of a facility name of the event holding facility, the event holding facility can be searched using the facility name after the change without needing an annual update of the navigation DB.

Furthermore, in this embodiment, the facility search control section 15 accepts searching of an event holding facility using a facility name before the change even in the case where the characters of the facility name before the change were inputted after changing the facility name.

As described above, according to this embodiment, since event holding facility can be searched based on an event name, desired event holding facility can be searched regardless of the change of name due to the influence or the like of naming rights business.

Note that the present invention is not limited to the foregoing embodiments, but various modifications can be made if necessary. For example, the present invention may be applied for searching a sport team exclusive facility using equipment other than the on-vehicle navigation device (for example, mobile communication equipment of cell phone or the like).

According to the facility search device of the present invention, since an exclusive facility for a professional sport team can be searched based on a team name, the exclusive facility for a desired professional sport team can be searched regardless of the change of name due to the influence or the like of naming rights business.

Further, according to another facility search device by the present invention, by switching the display from the list of facility names to the list of team names, a correspondence between the list of facility names and the list of team names is observed.

Moreover, according to another facility search device by the present invention, since an exclusive facility for a desired professional sport team can be efficiently searched by previously narrowing down a subject to be searched, the exclusive facility for a desired professional sport team can be quickly searched.

Furthermore, according to another facility search device by the present invention, regarding a facility that a user recognizes by a name other than an official name of the facility, such as an old name, an abbreviated name, and a commonly used name, the exclusive facility can be searched more easily by displaying a name other than the current official name (old name, abbreviated name, commonly used name or the like). Accordingly, the exclusive facility for a desired professional sport team can be searched more efficiently.

Further, according to another facility search device by the present invention, since exclusive facility for a desired Minor League team as a professional sport team can be searched for based on the team name of a Minor League team, the exclusive facility for a desired Minor League team can be searched for regardless of the change of name.

Moreover, according to another facility search device by the present invention, since a detail search result regarding the exclusive facility for Minor League teams can be acquired, the search result can be substantial, and the usefulness of the search result can be improved.

Furthermore, according to another facility search device by the present invention, the exclusive facility for a desired Minor League team can be searched for based on a team name of a Minor League in U.S. professional baseball, so that the exclusive facility for a desired Minor League team can be searched for regardless of the change of the name.

Further, according to another facility search device by the present invention, since the exclusive facility for a desired professional sport team can be searched by inputting the characters of a team name, the exclusive facility for a desired professional sport team can be searched more conveniently.

Moreover, according to another facility search device by the present invention, in the case where the user knows the facility name, the exclusive facility for a desired professional sport team can be searched by inputting the characters of the facility name, so that the device can cope with conventional search.

Furthermore, according to another facility search device by the present invention, since a detail search result regarding the exclusive facility for a desired professional sport team can be acquired as a search result of facility by character input, the usefulness of the search result can be improved.

Further, according to another facility search device by the present invention, after the facility name is changed, an exclusive facility for a desired professional sport team can be searched for using the facility name after the change without needing to update the information regarding the date a name of a facility changed or the name of the facility after the change, thereby improving the connivance to a user.

Moreover, according to another facility search device by the present invention, even on or after the change date of a facility name, the exclusive facility for a desired professional sport team can be searched for using a facility name before the change, so that even a user who only knows the facility name before the change can search the exclusive facility for a desired professional sport team using the facility name, thereby improving the convienence to a user.

Furthermore, according to another facility search device by the present invention, since the device can cope with the current facility name without frequently updating the information of the change date of facility or the facility name after change, convenience can be further improved.

Further, according to another facility search device by the present invention, since a stadium that a desired professional sport team uses as a home can be searched based on the team names of professional sport teams, an exclusive stadium of a desired professional sport team can be searched regardless of the change of the name.

Moreover, according to another facility search device by the present invention, since the exclusive facility for live performance groups can be searched based on a group name, the exclusive facility for a desired live performance group can be searched regardless of the change of the name due to the influence or the like of naming rights business.

Furthermore, according to another facility search device by the present invention, by switching the display from the list of facility names to the list of group names, a correspondence between the list of facility names and the list of group names can be observed.

Further, according to another facility search device by the present invention, since the exclusive facility for a desired live performance group can be efficiently searched by previously narrowing down a subject to be searched, the exclusive facility for a desired live performance group can be quickly searched.

Moreover, according to another facility search device by the present invention, regarding a facility that a user recognizes by a name other than a current official name of the facility such as an old name, an abbreviated name, and a commonly used name, the exclusive facility can be searched more easily by displaying a name other than the current official name, so that the exclusive facility for a desired live performance group can be efficiently searched.

Furthermore, according to another facility search device by the present invention, since the exclusive facility for a desired live performance group can be searched by inputting the characters of a group name, the exclusive facility for a desired live performance group can be searched more conveniently.

Further, according to another facility search device by the present invention, in the case where the user knows a facility name, the exclusive facility for a desired live performance group can be searched by inputting the characters of a facility name, so that the device can cope with conventional search.

Moreover, according to another facility search device by the present invention, since a detail search result regarding the exclusive facility for a desired live performance group can be acquired as a search result of facility by character input, the search result can be substantial, and the usefulness of the search result can be improved.

Furthermore, according to another facility search device by the present invention, after the facility name is changed, the exclusive facility of a desired live performance group can be searched using the facility name after the change without updating the information of change date of facility or the facility name after the change, thereby improving the convienence for a user.

Further, according to another facility search device by the present invention, since the exclusive facility for a desired live performance group can be searched by using a facility name before the change even on or after the change date of facility name, even a user who only knows the facility name before the change can search an exclusive facility of a desired live performance group using the facility name, thereby improving the convienence for the user.

Moreover, according to another facility search device by the present invention, the device can cope with a current facility name without frequently updating the information of the change date of facility or the facility name after the change, so that its convenience can be further improved.

Furthermore, according to another facility search device by the present invention, since a desired theater or a concert hall can be searched based on a theater company name or an orchestra name, the desired theater or the concert hall can be searched regardless of the change of name.

Further, according to another facility search device by the present invention, since an event holding facility can be searched based on an event name, a facility holding a desired event can be searched regardless of the change of name due to the influence or the like of naming rights business.

Moreover, according to another facility search device by the present invention, by switching a display from the list of facility names to a list of event names, a correspondence between a facility name and an event name can be obtained.

Furthermore, according to another facility search device by the present invention, since a facility holding a desired event can be efficiently searched by previously narrowing down a subject to be searched, the facility holding a desired event can be quickly searched.

Further, according to another facility search device by the present invention, regarding a facility that a user recognizes by a name other than a current official name such as an old name, an abbreviated name, and a commonly used name, the exclusive facility can be searched more easily by displaying a name other than the current official name, so that the facility holding a desired event can be searched more securely.

Moreover, according to another facility search device by the present invention, since a facility holding a desired event can be searched by inputting the characters of an event name, the facility holding a desired event can be searched more conveniently.

Furthermore, according to another facility search device by the present invention, in the case where the user knows a facility name, the facility holding a desired event can be searched by inputting the characters of a facility name, so that the device can cope with conventional search.

Further, according to another facility search device by the present invention, since detail search result regarding the facility holding a desired event can be acquired as a search result of a facility by character input, the search result can be substantial, and usefulness of the search result can be improved.

Moreover, according to another facility search device by the present invention, after a facility name is changed, a facility holding a desired event can be searched using the facility name after the change without updating the information of change date of facility or the facility name after the change, so that its convenience can be improved.

Furthermore, according to another facility search device by the present invention, since a facility holding a desired event can be searched using the facility name before the change even on or after the change date of facility name, even a user who only knows the facility name before the change can search the facility holding a desired event using the facility name, and its convenience can be further improved.

Further, according to another facility search device by the present invention, the device can cope with a current facility name without frequently updating the information of the change date of a facility or the facility name after the change, so that its convenience can be further improved.

Moreover, according to another facility search device by the present invention, since a facility holding a desired sport event can be searched based on the event name of a sport event, the holding facility of a desired sport event can be securely searched regardless of the change of the name.

Furthermore, according to another facility search device by the present invention, in the on-vehicle navigation device, a desired facility as a destination candidate can be securely searched regardless of the change of the name. Hence, setting of a destination can be smoothly performed.

It is therefore intended that the foregoing detailed description be regarded as illustrative rather than limiting, and that it is understood that it is the following claims, including all equivalents, which are intended to define the spirit and scope of this invention.

What is claimed is:

1. A facility search device that searches for an exclusive facility associated with a professional sport team, wherein the device is operative to search for the exclusive facility for a professional sport team based on a team name of said professional sport team.

2. The facility search device of claim 1, wherein the facility search device comprises:
a sport facility name list display processing device operative to display a list of facility names associated with a professional sport team on a display section;
a sport team name list display processing device operative to display a list of team names associated with each facility in the list of facility names displayed on the display section in the state where a relation between a facility name and a team name is distinguishable; and
a display switching processing device operative to switch between the display of the list of facility names by the sport facility name list display processing device and the display of the list of team names by the sport team name list display processing device, the display switching processing device switching between the displays based on an input operation of a user,
wherein the facility search device is operative to search an exclusive facility for a professional sport team based on a team name by switching the display of the list of said facility names and the display of the list of said team names.

3. The facility search device of claim 2, wherein the facility search device further comprises:
a type input device operative to receive an input associated with at least one of a facility type and a professional sport type, wherein the input is selected from a plurality of candidate facility types and a plurality of professional sport types; and
an address input device operative to receive a facility address;
wherein the sport facility name list display processing device and the sport team name list display processing device are formed to display the list of facility names or team names regarding an exclusive facility for a professional sport team corresponding to the input received by the type input device and the address input device on said display section.

4. The facility search device of claim 2, wherein the sport facility name list display processing device is operative to display a plurality of names regarding the same facility.

5. The facility search device of claim 2, wherein the facility search device is operative to search for an exclusive facility for a professional sport team using a database storing information regarding exclusive facilities for professional sport teams, information regarding a date of name of a facility changes, and information regarding a name of the facility after the change, the database including information regarding changes in the facility name that will occur in the future, and
wherein on and after a date the name of the facility is changed, the device is operative to search for an exclusive facility for a professional sport team based on a name of the facility after the change.

6. The facility search device of claim 1, the facility search device comprising:
a sport type input device operative to receive an input of a professional sport type selected from a plurality of candidate professional sport types;
a first sport team name list display processing device operative to display a list of team names of professional sport teams that are associated with a professional sports type received by the sport type input device on a display section in the state that a user can select a team in the displayed list of team names of professional sport teams;
a second sport team name list display processing operative to display a list of team names of Minor League teams that are affiliated with a team selected by the user out of the list of team names displayed by the first sport team name list display processing device, the list of team names of Minor League teams displayed on the display section such that the user can select a Minor League team in the list; and
a Minor League team display processing device operative to display information regarding an exclusive facility associated with a Minor League team selected by the user out of the team names of Minor League teams displayed by the second sport team name list display processing device.

7. The facility search device of claim 1, the facility search device comprising:
a team name character input device operative to receive an input of characters of a team name of a professional sport team; and
a facility information display processing device operative to display information regarding an exclusive facility for a professional sport team corresponding to the team name received by the team name character input device on the display section.

8. The facility search device of claim 7, the facility search device comprising:
a facility name character input device operative to receive an input of characters of a facility name of an exclusive facility for a professional sport team,
wherein the facility information display processing device is also operable to display information associated with an exclusive facility for a professional sport team corresponding to the facility name received by said facility name character input device on a display section.

9. The facility search device of claim 7, wherein the facility information display processing device is operative to display at least one of an address and a peripheral map as the information of said exclusive facility for a professional sport team together with a facility name.

10. The facility search device of claim 1, wherein the facility search device is used in an on-vehicle navigation device.

11. A facility search device that searches for an exclusive facility associated with live performance groups, the facility search device operative to search for an exclusive facility for live performance groups based on a group name of the live performance group.

12. The facility search device of claim 11, the facility search device comprising:
a live performance facility name list display processing device operative to display a list of facility names associated with the exclusive facility for live performance groups on a display section;
a group name list display processing device operative to display a list of group names corresponding to each facility in the list of facility names on the display section in the state where a relation between a group name and a facility name is distinguishable; and
a display switching processing device operative to switch the display of the list of facility names by the live performance facility name list display processing device and the display of the list of group names by the group name list display processing device based on an input operation of a user;
wherein the facility search device is operative to search for an exclusive facility for live performance groups based on a group name by switching the display of the list of said facility names and the display of the list of said group names.

13. The facility search device of claim 12, the facility search device comprising:
a type input device operative to receive an input of at least one of a facility type and a performance content type, the received input one of a plurality of candidate facility types and a plurality of candidate performance content types; and
an address input device operative to receive an input of a facility address;
wherein the live performance facility name list display processing device and the group name list display processing device are operative to display the list of facility names or the list of group names associated with the exclusive facility for live performance groups corresponding to the input received by the input device and the input received by the address input device.

14. The facility search device of claim 12, wherein the live performance facility name list display processing device is operative to display a plurality of names associated with the same facility.

15. The facility search device of claim 12, wherein the facility search device is operative to search for the exclusive facility for live performance groups using a database storing information regarding exclusive facilities for live performance groups, information regarding a date a name of a facility for live performance groups will change, and information regarding a name of the facility after the name change, the database storing information regarding a change of a facility name that will occur in the future, on and after a date of a change of the facility name, the device is operative to search for an exclusive facility for live performance groups using a facility name after the change.

16. The facility search device of claim 15, wherein on and after the date of the change of the name of the facility, the facility search device is operative to search for an exclusive facility for live performance groups using a facility name before the change of the name of the facility.

17. The facility search device of claim 11, the facility search device comprising:
a group name characters input device operative to receive an input of characters of a group name for live performance groups; and
a facility information display processing device that is operative to display information associated with an exclusive facility for live performance groups corresponding to the group name received by the group name characters input device.

18. The facility search device of claim 17, the facility search device comprising:
a facility name character input device operative to receive an input of characters of the facility name of an exclusive facility for live performance groups;
wherein the facility information display processing device is further operative to display information of an exclusive facility for live performance groups corresponding to the facility name received by the facility name character input device.

19. A facility search device that searches for a facility holding an event, wherein the facility search device is operable to search for the facility holding an event based on an event name.

20. The facility search device of claim 19, wherein the facility search device comprises:
a holding facility name list display processing device operative to display a list of facility names holding an event on a display section;
an event name list display processing device operative to display a list of event names associated with each facility in the list of facility names in the display section in the state where a relation between an event name and a facility name is distinguishable; and
a display switching processing device operative to switch the display of the list of facility names by the holding facility name list display processing device and the display of the event name list by the event name list display processing device based on an input operation of a user;
wherein the facility search device is operative to search for the facility holding an event based on an event name by switching the display of the list of facility names and the display of an event name list.

21. The facility search device of claim 20, the facility search device comprising:
a type input device operative to receive an input of at least one of a facility type and an event type, the input selected from one of a plurality of candidate facility types and a plurality for candidate event types; and
an address input device operative to receive an input of a facility address;
wherein the holding facility name list display processing device and the event name list display processing device are operative to display the list of facility names or the group names associated with the facility holding an event corresponding to the input by the type input device and the address input device.

22. The facility search device of claim 20, wherein the holding facility name list display processing device is operative to display a plurality of names regarding the same facility.

23. The facility search device of claim 19, the facility search device comprising:
an event name character input device operative to receive an input of the characters of an event name; and
a facility information display processing device operative to display information regarding the facility holding an event corresponding to the event name received by the event name character input device.

24. The facility search device of claim 19, wherein the event includes a sporting event.

25. The facility search device of claim 19, wherein the device is used in an on-vehicle navigation device.
